(19) United States
(12) Patent Application Publication
(10) Pub. No.: US 2018/0197437 A1
(43) Pub. Date: Jul. 12, 2018

(54) Waist watcher belt

(71) Applicant: Glenn Trachsell, Cambridge (CA)

(72) Inventor: Glenn Trachsell, Cambridge (CA)

(21) Appl. No.: 15/530,433

(22) Filed: Jan. 10, 2017

(51) Int. Cl. G09B 19/00; A41F 9/02; G09B 5/06

(52) U.S. Cl. CPC G09B 19/0092; G09B 5/06; A41F 9/025

(57) ABSTRACT

Although Billions of dollars are spent each year on weight reducing programs many are not successful and are known as the Yo Yo diet; loose ten pounds then gain twenty pounds, it is easy to slip back to crave prepared food that are loaded with sugar, fat or salt. Temptation to overeat unhealthy food are everywhere. unless you have goals attainable and a way of keeping track of them so you can resist the temptation.This invention uses three well known motivators See Touch and Hear to help you change Bad Habit into Good Habits. A replica of your belt is on the refrigerator. It has a LED Screen, Wi Fi. and four receptacles for four goals which could be as simple as not having a donut with your coffee or instead of a glass of orange juice which has 3 or 4 oranges have half a orange for breakfast. Waist Watchers Belt is a one time purchase. if you follow the Plan no longer will you contribute to the Billions of Dollars each year.

### BACKGROUND OF THE INVENTION

USA Today Sep. 16, 2014: Abdominal obesity starts at 40.2 inch waist for men and a 34.6 waist for women: bellies that big are linked with increased risk of diabetes and heart decease

ABC News May 8, 2012 that the annual revenue of the U.S. weight-loss industry was $20 Billion, including diet drugs and surgeries.

Psychologist Traci Mann, who has spent 20 years running an eating lab at the University of Minnesota says, the evidence is clear. “It couldn't be easier to see, “Long-term weight loss happens to only the smallest minority of people”.

billions of dollars are spent on programs each year that only help the smallest minority of people it is time to think outside the box.

It is evident from the above discussion that what is needed is a plan which is a Lifeline to resist overeating. Changing ones bad eating habits back to healthy eating habits is the embodiment of this invention.

On the Waist Watcher Belt are four inserts with goals 1,2,3 and 4. Unlike many other weight loss programs your goals go with you: therefore it is much easier to resist the temptation to overeat.

Motivational speakers for years at sales congresses have used sight and touch of the Five Senses to motivate people to attain their goals: by listing Goals on a 3 by 5 memo card. Put in ones pocket or purse, if tempted to procrastinate on goals, you touch or look at the goals on your memo card and so doing it makes it easier to resist thetemptation.

This invention's embodiment for the motivation to loose weight uses Touch, Sight and Sound; three of the Five Senses.

Touch: touching the embossed Dot or Dots representing one of your four goals on the metal insert helps one resist any temptation.

Sight: seeing a replica of your belt magnetized to the refrigerator with its 4 receptacles for your set goals helps you to not overeat.

Sound: the belt replica can be programmed to motivate attainment of goals or keeping in touch with like Waist Watcher Belt people.

putting on your belt you see Goal 2, it is to have a half an orange instead of a glass of orange juice, which equals eating 3 or 4 oranges.

goal 3 is; at coffee break instead of double double the plan is one cream and not the usual doughnut. If tempted to stray from your goal, you touch the insert with embossed goal 3 on it to resist the temptation.

When you no longer crave what is called a treat, remove your goal insert and place it in the replica of your belt on the Fridge.

it is a known fact it takes about a month to change a bad habit into a good habit and no longer crave such things as sugar or greasy food.

This invention lets you set goals, then helps motivate you to attain those goals by each one inch insert removed from your belt.

This invention does not keep track of goals by weighing oneself, counting calories, burning calories, exercising, prepared recipes or surgery.

Not unlike the Memo Card promoted as a motivator by speakers at conventions, this invention helps you resist temptation by embodying three of the Five Senses which are: Touch, Sight and Sound.

Touch: inserts have Goal 1 to 4 engraved on the inside, on the outside are embossed dots that represent these numbers. When tempted to eat something not in the plan, touching the Dot of a particular goal helps motivate one to stay within the plan: which is to remove the insert and place it in the receptacle on the Fridge.

Sight; magnetized attached to the refrigerator is a replica of the belt which has 4 indented spaces for goals 1,2,3 and 4. With each lost inch around the waist, you unscrew the insert from the belt and place it in the replica of the Belt on the Fridge.

Sound: each belt like receptacle has a memory card to record your goals which can be played by a touching the LED lit belt holes

Extra options would be Wi Fi and a LED Screen that lets you download motivational material or tex other Waist Watcher Belt users.

The embodiment of this invention is to change bad eating habits into good eating habits using touch sight and sound, along with set goals. You no longer will be the one that contributes to the billions of dollars that is spent each year on weight loss programs.

### BRIEF SUMMARY OF THE INVENTION

Without the expected results billions of dollars are spent each year on weight loss programs. Nullifying this expenditure are billions of dollars spent encouraging people to eat foods that contain sugar, fat ,grease or salt, which all are addictive and create bad habits.

If eating habits are not changed, what is known as YoYo diets loose 10 pounds gain 20. It can happen when motivated for a special occasion.

Changing bad habits for good habits is what this invention is designed to do. The embodiment of this invention is three of the Five Senses; Touch, Sight and Sound; well established Norms that motivational speakers have used for years to help people improve their life style.

Sight: getting dressed putting on your belt, you see the embossed insert witch has one of your goals to change a habit at breakfast. Instead of having the usual glass of orange juice which is equal to three or four oranges you are having half an orange which is as least 40% less sugar.

Touch: later in the day it could be to change a habit at Coffee Break instead of Double Double in your coffee, have just one cream and not have your usual doughnut. If tempted to do otherwise touch the designated goal on your belt which helps you resist that temptation.

Sound: placing one of your goals in the receptacle plays a jingle, or positive thoughts of your choice or notify others of your progress.

Waist Watcher Belt is one time purchase. By following The Plan, one no longer contributes to the billions of dollars spent each year on dieting.

### BRIEF DESCRIPTION OF THE DRAWINGS

The above mentioned and other features, advantages and objects of this invention, and the manner of attaining them, will become apparent and the invention itself will be better understood by the following description of embodiment of the invention taken in conjunction with the accompanying drawings, wherein:

FIG. 1 is a top perspective view an exemplary embodiment of man or woman belt. It has four removable hinged inserts. As each goal is met the insert is removed from the belt and is placed in the belt receptacle that is attached to the refrigerator by magnet.

FIG. 2 is a part sectional view of the embodiment of inserts that contain goal's 1 2 3 and 4. It shows how the bolts which attaches the hinges are inserted from the bottom up. The half hinges are permanently attached to the belt

FIG. 3 is a perspective view of embodiment of further description of this inventions belt where a half hinge is sewed and glued into place in a lined belt.

FIG. 4 is a perspective view of embodiment of a half hinge that clamps on to a single layer belt

### DETAILED DESCRIPTION OF THE INVENTION

### First Embodiment

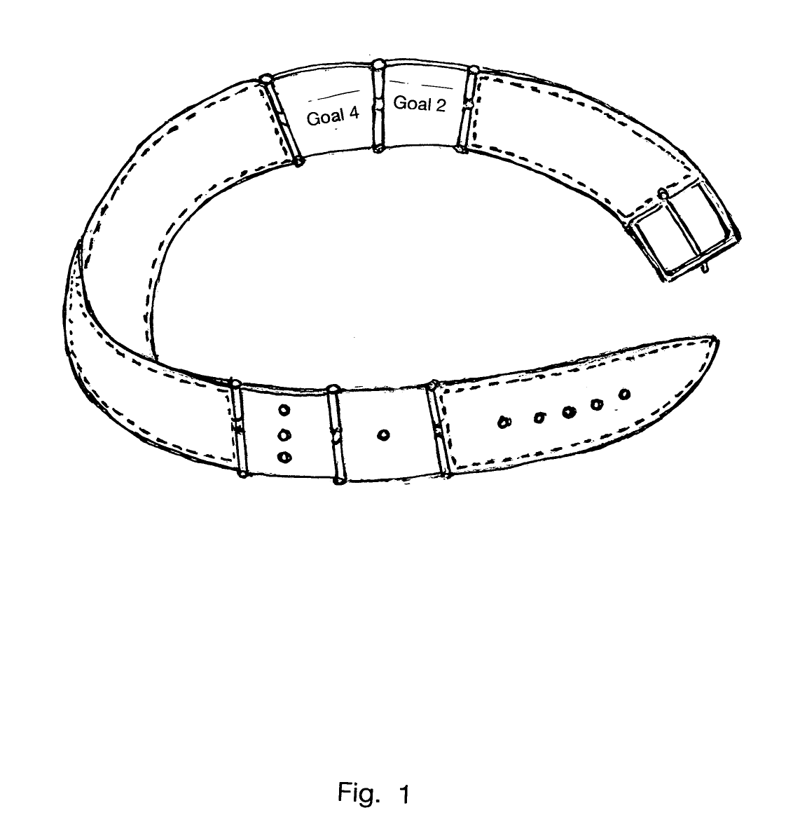

### FIG. 1

This disclosure is embodiment of a weight loss plan that is part of ones wardrobe in which your planned goals go with you. If tempted to overeat food not in the plan touching this inventions belt insert with your goal on it helps one resist the temptation.

Referring now to the drawings embodiment is FIG. 1 that shows a schematic view assembly of this invention. Material for the belt section shown is hand stitched leather. it also can be other materials that are marketed such as webbing for heavy labour or sports.

There are four inserts made of metal that are hinged and removable. On the inside engraved is Goal followed by 1 2 3 or 4: on the outside corresponding embossed Dots.

The outside of the metal inserts are embossed dots corresponding to the etched goals printed on the inside. One dot is in the middle for Goal 1. Two dots one above each other in the middle for Three dots in the middle above each other for 3 and Four dots in each corner for 4.

### Second Embodiment

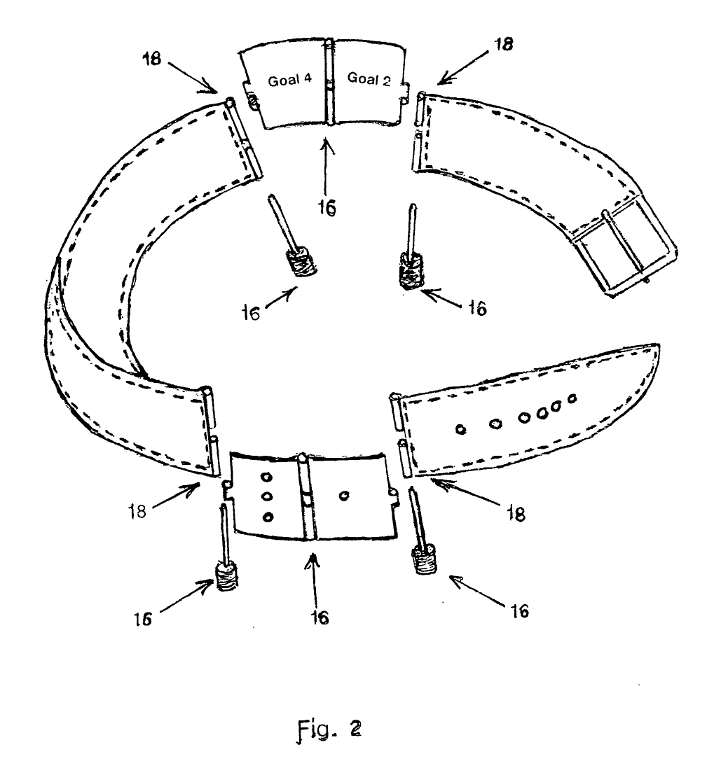

### FIG. 2

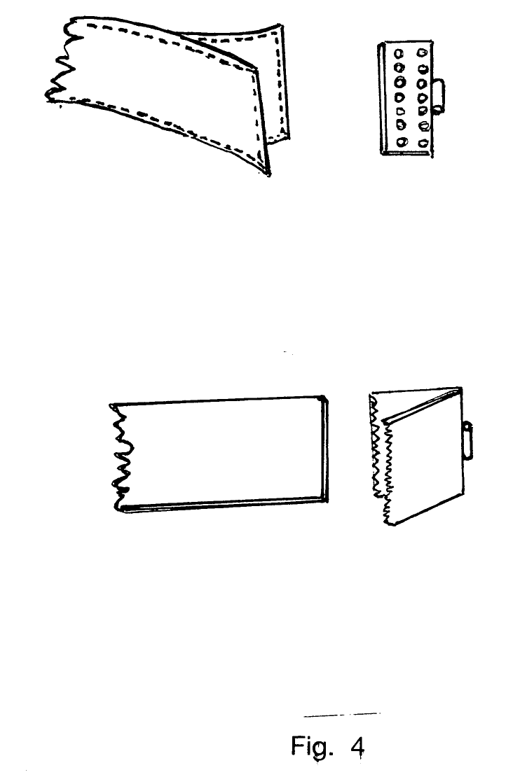

half Hinged inserts are sewn and glued into the leather belt. If man made material such as webbing FIG. 4 the half hinge is clamped and glued.

There are three material inserts 14 that can be leather or man made material. Making adjustment to a larger waist size is done by extending the material or leather connected to three of the non metal inserts: buckle section, the back strip and the buckle holes section.

By extending the material or leather the metal goal inserts will ride above the hips. Adding more metal inserts results in to many goals; therefore by extending material for larger sizes makes sure there is only four goals at one time.

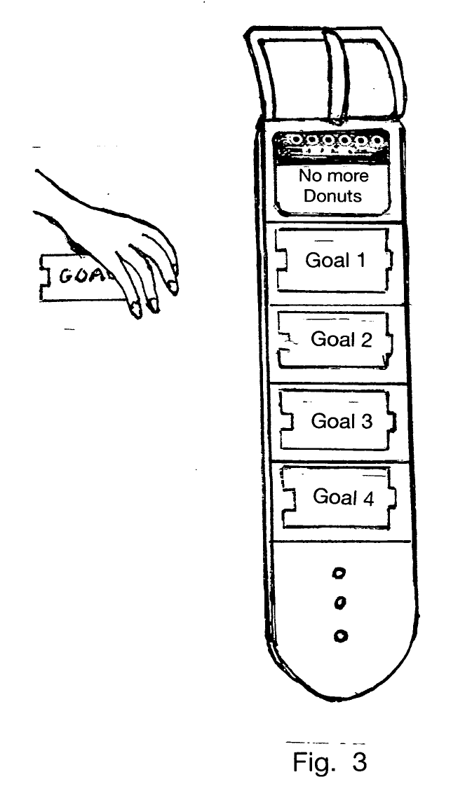

On the inside of the metal inserts are inscribed Goal 1 Goal 2 Goal 3 and Goal 4. as each goal is attained it is placed in the belt like FIG. 3 receptacle on the refrigerator with the inscribed Goal 1 Goal 2 Goal 3 and Goal 4.

The four metal goal inserts are hinged with bolts penetrating short of the Crown from the bottom up so only the crown shows.

each bolt is partially threaded ½ inch at the lower part only, the remaining part of the barrel is smooth allowing easy and quick removal of inserts. This bolt does not penetrate the Crown. Slots in the bottom of the bolt requires a Philips screw driver included for removal.

### Additional Embodiment

### FIG. 3

FIG. 3 belt like receptacle is magnetized to secure goal inserts 22 and secure itself to the refrigerator. Each space from Goal 1 to Goal 4 has its goal inscribed in the receptor's magnetized space.

An LED screen 20 programs your goals, is connected by WiFi and is controlled by the 3 belt holes programming touch screen.

3 LED lights at night remind you of your goals. they control a jingle when a goal is placed in the rector, and other such as recordings.

FIG. 4 hinge a partial hinge FIG. 4 inserted between the outer belt and the lining, which can be glued in, stitched in, riveted in. If material is man made such as webbing and does not have a lining it has a Clasp FIG. 4.

What is claimed is:

1. A method for setting goals to reduce body mass by reducing the waist line of over weight people. Make Sense Belt encourages waist reduction inch by inch. by taking advantage of 3 of the Five Senses.
Along with the “Make Sense Belt” is a “Receptacle” magnetically attached to the refrigerator which accommodates and registers the inserts; goals of 1,2,3 and 4 as they are removed from the belt one inch at a time as waist is reduced.
A “Belt” of leather, web or any other composition used in a belt Contains these inserts. The progress of weight and inches loss of an individual are then recorded ion a receptacle (to see an individual's progress). The receptacle attached to the Fridge (which is connected by Wi Fi); allows communicating with other like same waist watchers.
Inserts of stainless steel, silver or any metal or other material that can be embossed that are removed from the belt as each goal is reached, then placed in the receptacle on the refrigerator which records information such as Goals.
Embossed on each insert is a Goal 1,2,3,4 (numerals on the inside). On the outside inconspicuously are embossed dots of 1,2,3, and 4. When tempted to overeat touching your Goal 1,2,3 or 4 reminds you of your commitment to not overeat.
Inserts threaded to the belt by screws from the bottom up, thus the head of the insert does not reveal there purpose for weight loss and are detachable as inserts.
The Make Sense Belt is designed to take advantage of 3 of the “Five Senses” which are “Touch, Sight and Sound”, well known motivators.
Touch; in order to have the sense of touch the inside of the insert has the person's goal and its # on the interior side. On the the outside are dots representing its goal of the wearer. Both are embossed so the person knows when touched what there goal is.
Sight: A receptor that's design is a replica of the belt magnetized to be on the refrigerator in plain site. There is magnetic spaces for each of the inserts. The base is magnetized and contains electronics and battery for a touch screening Wi Fi. The touch screen records data of progress in waist reduction.
Sound; a sensor in the receptor (if turned on) activates a recorded message of Positive thinking that the owner has recored or downloaded.
Four Inserts each belt, if larger size belt the back of the belt is extended in 4 inch increments.
